(19) United States
(12) Patent Application Publication
(10) Pub. No.: US 2005/0030171 A1
(43) Pub. Date: Feb. 10, 2005

(54) COOLING SYSTEM FOR COMPUTING DEVICE

(76) Inventors: Tse-Hung Liu, Taipei Hsien (TW); Cha-Cheng Weng, Taipei Hsien (TW); Chia-Cheng Sun, Taipei Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/604,644

(22) Filed: Aug. 6, 2003

(51) Int. Cl. G08B 23/00

(52) U.S. Cl. 340/500

(57) ABSTRACT

A cooling system includes a cooling fan, a fan input-output module for transmitting a control signal for controlling the rotational speed of the fan, a clock rate, and an operating voltage, and a chipset interface for generating the fan control signal based on a change in a vital temperature of the computer system. Further provided is a controller for receiving the vital temperature and forwarding the vital temperature to the chipset interface, and a temperature transducer for generating the vital temperature and outputting the vital temperature to the controller. The chipset interfacemonitors a rotational speed of the cooling fan, and monitors a vital temperature of the computer system. The chipset interface then sets the fan power based on a change in the vital temperature. When the vital temperature decreases, the fan power is reduced to slow the fan, and when the vital temperature increases, the fan power is increased to speed the fan.

### BACKGROUND OF INVENTION

1. Field of the Invention

The present invention relates to a cooling system, and more specifically, to a cooling system for a computer.

2. Description of the Prior Art

As computer processing speeds steadily increase, the need for high capacity cooling systems becomes essential. Proper cooling prevents heat related failure of the processor when under operating loads. Typical cooling systems have progressed beyond the venerable constantly running fan to include temperature sensors and related control circuits for dynamically adjusting fan speed. While several fan speed control schemes have been developed, nearly all focus on maximizing cooling effects or reducing power consumption.

In the article Hanrahan, D. “Fan-Speed Control Techniques in PCs”Analog Dialogue Vol.34, No.4 (June-July 2000), which is incorporated herein by reference, several fan speed control schemes and circuits are described in detail. The first is a two-step fan control method in which a thermistor installed near a CPU or an on-die thermal monitoring transistor outputs a system temperature to a BIOS. The BIOS then switches a cooling fan on or off depending on the system temperature, a marked improvement over a constantly running fan. Similar to the two-step method, a three-step fan control method adds an additional half-speed setting for the fan. The half-speed setting is enabled when the processor is engaged in light duty generating little heat. The third method, a linear fan-speed control method, includes digital logic components that enable a range fan speeds based on the measured system temperature. The linear method is quite simply an extension of the three-speed method. Finally, a similar pulsewidth-modulation fan-speed control method allows fan speed to be controlled by adjusting fan signal duty cycle. While these are just a sampling of conventional fan speed control methods, they are representative of the current technology.

To realize linear fan-speed control methods such as that described above, circuits having the required operational logic have been developed. FIG. 1 illustrates a general state-of-the-art computer fan speed control circuit 10. The circuit 10 includes a fan 12 connected to a chipset controller 14 through a fan input-output interface 16. Generally, the chipset controller 14 contains logic linearly relating fan speeds to measured temperatures, and generates and outputs a corresponding control signal. Based on a temperature measured at a sensor 18, the chipset controller 14 outputs the control signal to the fan I/O 16, which controls the rotational speed of the fan 12. In an example of a specific conventional implementation, sub-components of the blocks of the circuit 10 are as disclosed in Steele, J. “An I²C Fan for Personal Computers” Electronic Design Aug. 3, 1998, which is incorporated herein by reference. In an example of a linear fan-speed control method, the chipset controller 14 is programmed with a series of trigger temperatures and a corresponding series of signals having encoded fan speeds, which are directly proportional to the series of trigger temperatures. Thus, the controller 14 outputs a fan control signal identifying a fan speed corresponding to the temperature trigger reached.

The prior art cooling systems described do not suitably meet current cooling requirements. Having been developed for performance and power savings, these methods typically suffer in other areas of concern. Specifically, noise levels can be uncomfortably high in conventional fan cooling applications.

### SUMMARY OF INVENTION

It is therefore a primary objective of the claimed invention to provide a cooling system for a computer that minimizes fan noise level while improving cooling performance and power conservation.

It is therefore another objective of the claimed invention to provide a cooling system for a VGA chipset that minimizes power consumption and fan noise level while improving cooling performance.

Briefly summarized, the claimed invention method monitors a rotational speed of at least a cooling fan of the computer system, the rotational speed of the cooling fan being controlled by a fan power, and further, monitors a vital temperature of the computer system. The method then sets the fan power based on a change in the vital temperature. When the vital temperature decreases, the fan power is reduced to slow the fan rotational speed, and when the vital temperature increases, the fan power is increased to increase the fan rotational speed.

A method according to the claimed invention monitors a rotational speed of a cooling fan installed on the VGA chipset, the rotational speed of the cooling fan being controlled by a fan power, and further, monitors a vital temperature of a graphics processor of the VGA chipset. The method then, increases the fan power when the vital temperature is substantially above a first threshold to increase the fan speed, and decreases the fan power when the vital temperature is substantially below the first threshold to decrease the fan speed. The method finally, increases the operating clock speed or voltage of the processor when the vital temperature is substantially below a second or third threshold respectively, and decreases the operating clock speed or voltage of the processor when the vital temperature is substantially above the second or third threshold respectively.

According to the invention, the method can further increase the fan power by a first power when the vital temperature increases by a first temperature, and decrease the fan power by a second power when the vital temperature decreases by a second temperature. The first power is directly proportional to the first temperature, and the second power is directly proportional to the second temperature.

According to the invention, the cooling fanscontrolled include a CPU cooling fan, an auxiliary cooling fan, or a power supply cooling fan, and the vital temperature is obtained from an on-die thermal monitoring transistor of the CPU.

According to the invention, a VGA cooling system includes a graphics processor, a cooling fan for cooling the graphics processor, and a fan input-output module for transmitting a fan rotational speed control signal to the fan. The VGA cooling system further includes a controller having fan logic for generating the fan control signal based on a vital temperature of the graphics processorand outputting the fan control signal to the fan input-output module, and power logic for generating a operating power control signal based on the vital temperature of the graphics processor and outputting the operating power control signal to the graphics processor. Finally, the VGA cooling system includes a temperature transducer connected to the graphics processor for measuring the vital temperature and outputting the vital temperature to the controller.

It is an advantage of the claimed invention that the differential consideration of temperature, that is, the measurement of the change in vital temperature, improves the control of the fan speed.

It is a further advantage of the claimed invention that the differential consideration of temperature and the corresponding differential setting of the fan speed result in reduction in fan speed, and thus, fan noise and power consumption.

It is an advantage of the claimed invention that reducing the fan speed when the vital temperature is low reduces fan noise and power consumption.

It is a further advantage of the claimed invention that increasing the operating voltage or clock speed of the graphics processor in concert with decreasing the fan speed improves performance of the graphics processor and lessens fan noise when the VGA chipset is under low processing loads.

It is a further advantage of the claimed invention that reducing the operating voltage or clock speed of the graphics processor while increasing the fan speed effectively cools the graphics processor when under high processing loads.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a computer cooling system according to the prior art.

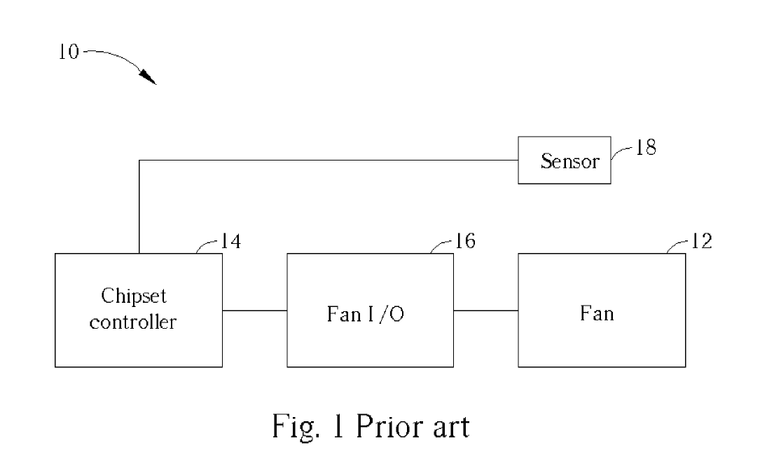

FIG. 2 is a schematic diagram of a computer cooling system according to the present invention.

FIG. 3 is a flowchart of a first method according to the present invention.

FIG. 4 is a flowchart of a second method according to the present invention.

FIG. 5 is a diagram of a user interface according to the present invention.

FIG. 6 is a diagram of a fan speed setting interface of the user interface of FIG. 5.

FIG. 7 is a schematic diagram of a VGA chipset cooling system according to the present invention.

FIG. 8 is a flowchart of a temperature control method according to the present invention.

FIG. 9 is a diagram of a user interface according to the present invention.

### DETAILED DESCRIPTION

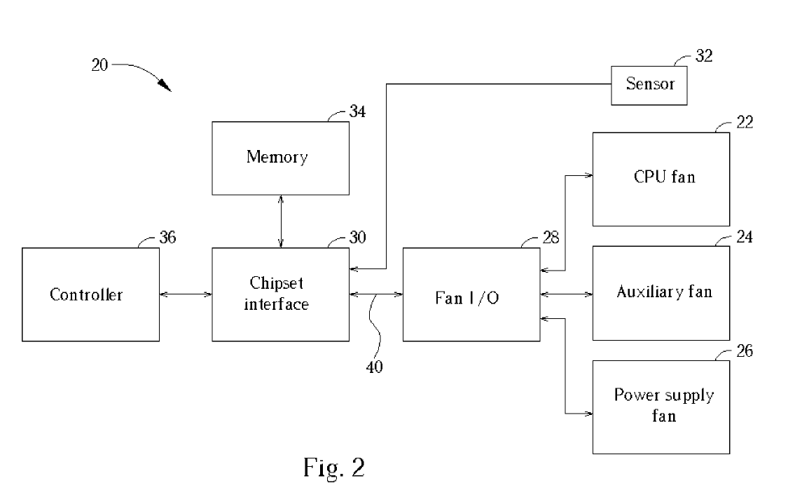

Please refer to FIG. 2 showing architecture of a cooling system 20 for a computer according to the present invention. The cooling system 20 includes a series of fans, of which all are optional as long as one is provided, including a CPU fan 22, an auxiliary (case) fan 24, and a power supply fan 26 installed in the computer. The fans 22, 24, 26 are three pin fans, the pins being power and ground pins for operation, and a tachometer output pin for rotational speed measurement. The CPU fan 22 is attached to a CPU heat sink, the auxiliary fan 24 is typically mounted inside the computer case near vent holes, and the power supply fan 26 is provided in the AC to DC power supply enclosure. The cooling system 20 can be applied in a wide variety of computer designs each having different fan arrangements. It is anticipated that many such implementations will include only the CPU fan 22, which is the most common active cooling device for modern processors. The cooling system further includes a fan input-output module 28 adapted to the number and types of fans used. The fan I/O 28 outputs analog control signals to the fans 22, 24, 26 based on digital control signals 40 received from a chipset interface 30. As most currently available fans require analog input, the fan I/O 28 facilitates the analog/digital conversion between the fans 22, 24, 26 and the chipset interface 30. The chipset interface 30 is connected to a temperature sensor 32, such as an on-die temperature sensitive transistor or a strategically placed thermistor, thermopile, or the like, to measure a vital temperature of the computer system. The sensor 32 can be located anywhere practical within the computer system, but an on-die transistor yields the most accurate results, and is standard on modern CPUs. The chipset interface 30 decodes and stores the temperature signal output by the sensor 32, and generates and outputs resulting control fan signals 40 to the fan I/O 28. To aid operation of the chipset interface 30 a memory 34 is provided to store relations of temperature to fan speed and other relevant data. Finally, the cooling system 20 includes a controller 36, such as a BIOS or an operating system (such as Microsoft Windows™ or Linux™), for controlling the chipset interface 30 and managing the overall operation of the cooling system 20. Aside from the auxiliary fan 24 and power supply fan 26, the hardware components of the cooling system 20 are typically provided on the computer motherboard.

In the preferred embodiment, the chipset interface 30 is software code executed by the processor of the computer system. That is, the chipset interface 30 comprises a set of instructions for the CPU to execute. In other embodiments, the chipset interface could include hardware instructions in a ROM, flash memory, or similar device. In practical applications, whether the chipset interface 30 is realized by software or hardware is determined by a skilled designer.

According to the preferred embodiment, the memory 34 stores the relationships between the vital temperature and fan speed for each of the fans 22, 24, 26. These relationships can be stored in tabular form or as computational algorithms in the memory 34. The chipset interface 30 then references a selected tabulated data or algorithm for the selected fan and generates the fan control signal 40 accordingly. In addition, the memory 34 is used by the chipset interface 30 for temporary storage of data required by processing operations. In practical application, the memory 34 is a hard disk, RAM, or BIOS memory of the computer system.

Operations of the fan I/O 28, the fans 22, 24, 26, and the sensor 32 are well known in the art, and one of ordinary skill in the art would be able to find ample references, in addition to those mentioned here, relating specific circuits and procedures for specific component selections. Thus, a variety temperature sensors and fans can be used, and the present invention is not limited by such design choices.

As described above, the chipset interface 30 generates the fan control signal 40. Depending on the number and type of fans used, the fan control signal 40 can have several encoded components. For example, if the CPU fan 22 and the auxiliary fan 24 are used, the fan control signal 40 comprises a CPU fan control segment and an auxiliary fan control segment, separated by time division, digital encoding, or a similar encoding scheme.

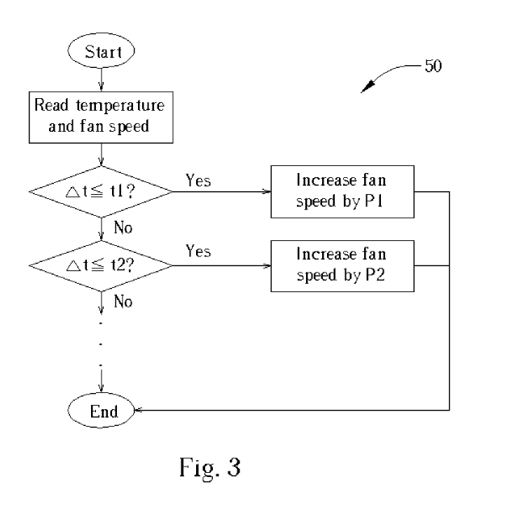

The chipset interface 30 determines and sets the fan speeds according to changes of the output of the temperature sensor 32. Before setting fan speeds, the chipset interface 30 measures the maximum RPM of each connected fan 22, 24, 26. This allows the chipset interface 30 to prevent over or under powering the fan, and to perform calculations and produce output as percentages of maximum fan speed. FIG. 3 illustrates a flowchart of a first method 50 performed by the chipset interface 30 according to the present invention. First, the sensor 32 outputs the measured temperature to the interface chipset 30. The tachometer of a fan 22, 24, 26 outputs a fan speed measurement to the interface chipset 30, so that when the chipset interface 30 modifies the fan speed it can ensure that the fan is not overpowered or stalled. Then, the chipset interface 30 calculates a level of a change in temperature, Δt, of the sensor 32 and compares the change with thresholds t1, t2, etc. Finally, the chipset interface 30 selects a corresponding change in fan speed, P1, P2, etc, and effects this change in fan speed by outputting a corresponding fan signal 40. The values and quantities of the change in temperature thresholds t1, t2, etc and the corresponding change in fan speeds P1, P2, etc can be selected referencing sound design principles. This procedure can be performed for all fans in the system, either sequentially or simultaneously. As a result, a measured change in vital temperature of the CPU or preferred measuring point is converted into a change in fan speed of a desired fan.

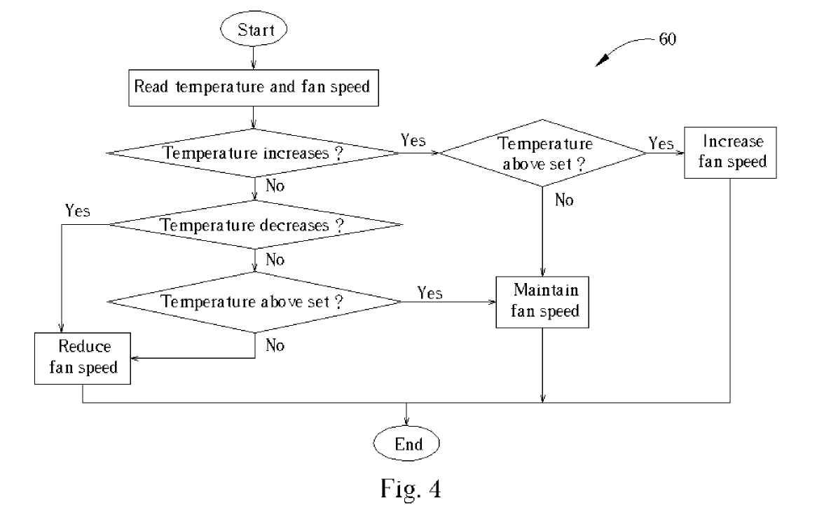

FIG. 4 shows a flowchart of a second method 60 according to the present invention. As in the first method 50, the sensor 32 and the tachometer of a fan 22, 24, 26 respectively output a temperature and a fan speed measurement to the chipset interface 30. Then, the chipset interface 30 determines if the vital temperature of the computer system has increased, decreased, or remained unchanged. The second method 60 further introduces a set temperature threshold for enhanced control, the set temperature being set based on design parameters of the computer system, such as heat sink quality, fan cooling effect, and normal processor activity. When the temperature increases, the chipset interface 30 compares the temperature level to the set temperature, increasing the fan speed when the temperature is above the set temperature and otherwise maintaining the fan speed. When the temperature decreases, the chipset interface 30 reduces the fan speed. When there is no significant change in the vital temperature, the chipset interface 30 maintains the fan speed if the temperature is above the set temperature and reduces the fan speed when the temperature is below the set temperature. The threshold determining a temperature change and the levels of fan speed change effected are selected based on the specific computer system design. Naturally, the above procedure shown in FIG. 4 can be performed sequentially or simultaneously for all fans in the system.

A sample of pseudo-code that realizes the second method 60 shown in FIG. 4 is given below:

Ti=current CPU temperature

Ti−1=previous CPU temperature

Tset=set temperature

PWM=fan speed as percentage of full speed

If Ti>Ti−1 and Ti>=Tset then

PWM=PWM+30%

(limit PWM to 100%)

Elself Ti>Ti−1 and Ti<Tset then

PWM=PWM

Elself Ti<Ti−1 then

PWM=PWM−20%

(limit PWM to 0%, or above stall speed)

Elself Ti=Ti−1

If Ti>Tset then

PWM=PWM

Else

PWM=PWM−20%

(limit PWM to 0%, or above stall speed)

Endlf

Endlf

To complement the second method 60 described above, catch-all fan speed levels are established to insure that at certain temperature levels relative to the set temperature, certain minimum fan speeds are maintained. These fan speed levels serve as insurance against the unpredictability of processor loading and consequent heat generation. A sample of pseudo-code for this is given below:

Tc=a critical operating temperature if the computer system

If Ti−Tset>0 and PWM<10% then PWM=10%

If Ti−Tset>3 and PWM<50% then PWM=50%

If Ti−Tset>6 and PWM<100% then PWM=100%

If Ti>=Tc then PWM=100%

For example, from the above, when the measured vital temperature is above the set temperature by 3 degrees, the fan speed is automatically set to half of full speed. In addition, if the temperature goes above the critical temperature, which is typically indicated by CPU manufacturers as a maximum operating temperature of the CPU before any CPU fail-safes initiate, the fan is automatically run at full speed. The incorporation of set fan speeds for set temperature ranges acts to supplement the differential fan speed control of the second method 60 of the present invention.

When computer system is being booted, is in the power-on self-test (POST) state, or is otherwise not under control of a conventional operating system, the present invention is performed by the BIOS. That is, the chipset interface 30 is realized with BIOS code executable by a BIOS processor under control of the controller (BIOS) 36, and the memory 34 is a BIOS memory accessible by the BIOS processor. It should be noted that even though the computer is booting or in the POST state, it can execute specially developed applications and therefore can generate significant amounts of heat. In this way, thermal management can be accomplished independent of operating system.

When the computer system is under control of an operating system, the present invention is performed by code executable under the operating system. The chipset interface 30 is realized with operating system executable code, such as code written and complied according to the C programming language. The memory 34 is a RAM or hard disk of the computer system, accessible by the operating system. Any application incorporating the present invention in both the operating system environment and the BIOS thus has two independent instruction sets and two separate memory elements. While this duality has advantages, such as redundancy and robustness, harmonization of the chipset interface code 30 and physical memory 34 is also possible. As such, thermal management can be accomplished under the operating system and under both the operating system and the BIOS of the computer.

Aside from one or both of the present invention temperature control methods 50, 60 described previously, the chipset interface 30 can also be programmed with well-known methods. The chipset interface 30 is then capable of switching between such well-known methods and the methods50, 60 according to the present invention. Examples of such well-known methods include the fixed fan speed control and multiple level fan speed control methods, with detailed descriptions being given in the description of the prior art. A suitable user interface or automatic control system is provided to the chipset interface 30 to realize switching between several temperature control schemes.

As mentioned, the chipset interface 30 controls the speed of the power supply fan 26 according the temperature measured by the senor 32. This reduces power consumption and fan noise by reducing an unnecessarily high speed of the power supply fan 26. When used to control the power supply fan 26, the method 50, 60 is set to consider heat generated by the power supply in addition to heat generated by the CPU. This is realized by precisely setting parameters, such as thresholds t1, t2 and fan speed increments P1, P2. That is, automatic shutdown of the power supply due to overheating as a result of low fan speed, initiated by a temperature sensitive switch or similar device, is prevented.

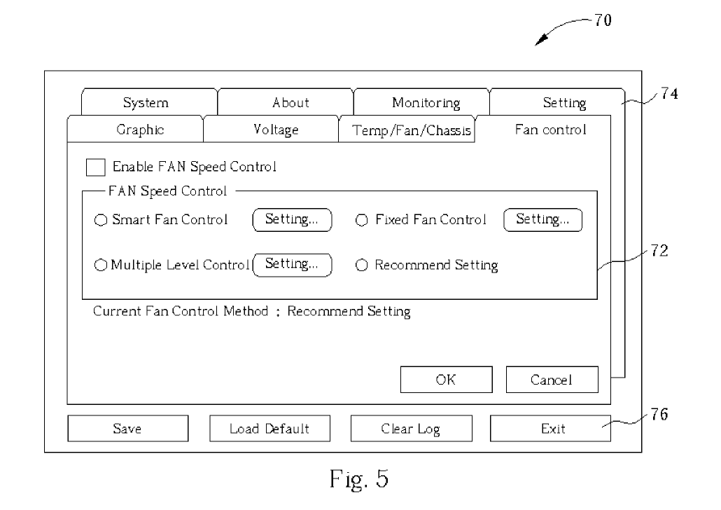

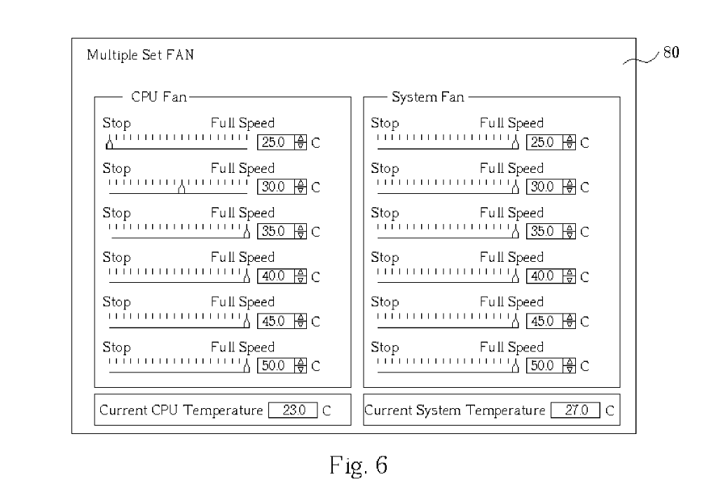

According to the present invention, the chipset interface 30 can be provided with a user interface to allow for user configuration of temperature control. Of interest to a user is selecting the specific temperature control method, configuring parameters influencing the selected method, and monitoring temperature and fan speed output. FIG. 5 illustrates such a user interface 70 according to the present invention. The user interface 70 is realized with a window in the operating system of the computer, and a similar user interface can be provided in the BIOS. An option to select between four modes of fan speed control is provided in the region 72. Further, panels 74 allow the user to access and configure different aspects of fan control, such as voltage settings and graphical output, and control buttons 76 provide a means of control, such as saving and exiting commands. When the user desires to configure fan speed control, they are presented with a window such as a fan speed setting interface 80 of FIG. 6. The fan speed setting interface 80 comprises several slider bars for setting fan speed corresponding to configurable temperatures levels for each fan included in the cooling system, realizing a configurable multilevel fan speed control system. Control of other cooling algorithms can be provided by similar windows. With user interfaces 70 and 80 and other similar interfaces, a user can finely tune the present invention cooling system according to his or her specific needs.

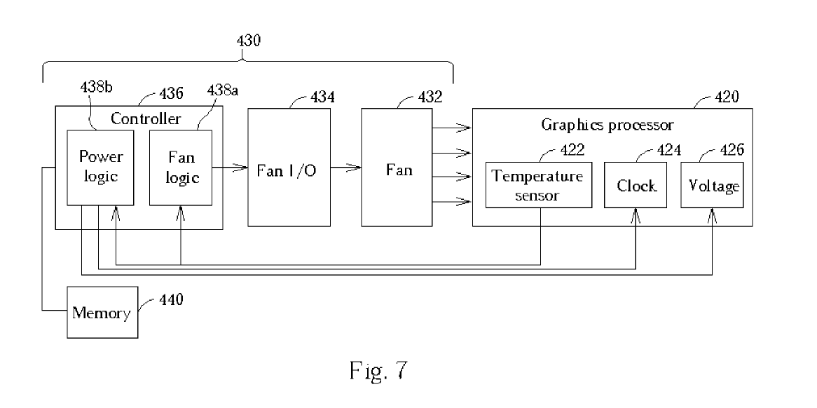

Next, a cooling system for an auxiliary component will be provided using graphics processor as an example. Please refer to FIG. 7 illustrating a schematic diagram of a present invention cooling system circuit 430 for cooling a graphics processor 420 of a VGA chipset, which is installed in a device such as a video card or PC main board. The cooling system 430 includes a cooling fan 432, a fan input-output module 434, and a controller436. The cooling fan 432 is physically connected to the graphics processor 420 through a heat sink or similar connection means. The fan I/O 434 electrically connects to the fan 432 and outputs an analog fan control signal to control the speed the fan 432. The controller 436 is electrically connected to the fan I/O 434 and outputs a digital fan control signal to the fan I/O 434. In this way, the controller 436 controls the speed of the fan 32 to provide variable cooling to the graphics processor 420.

The controller 436 controls the speed of the fan 432 through fan logic 438a based on temperature signals received from a temperature sensor 422 located on or near the graphics processor420. The fan logic 438a includes logic gates or program code executable by the controller 436. Ideally, the sensor 422 is an on-die temperature sensitive transistor of the graphics processor 420, however, a thermistor, thermopile or similar temperature sensor installed on or near the processor 420 or on a heat sink is also suitable. The fan logic 438a of the controller 436 generates a fan control signal appropriate to the measured vital temperature of the processor 420. Specifically, when the vital temperature is relatively high, the fan logic 438a generates a fan control signal that speeds the fan 432, and when the vital temperature is relatively low, the fan logic 438a generates a fan control signal that slows or stops the fan 432.

The controller436 can further control the heat produced by the graphics processor 420 by way of power logic 438b. The power logic 438b receives temperature signals from thetemperature sensor 432 and generates corresponding clock control and power control signals. The power logic 438b outputs the clock control signal and the power control signal respectively to a clock circuit 424 and a voltage circuit 426 of the graphics processor 420. The clock speed of the processor 420 is directly related to heat generation, the higher the clock rate, the more heat generated. The power logic 438b generates clock control signals that reduce the clock speed of the processor 420 when the vital temperature is high, and increase the clock speed of the processor 420 when the vital temperature is low. Changes in clock speed are of the order of tens of MHz. Similarly, the voltage at which the processor420 operates is also related to heat generation, with a higher operating voltage translating into higher heat generation. Accordingly, the power logic 438b also generates voltage control signals that reduce the operating voltage of the processor 420 when the vital temperature is high, and increase the operating voltage of the processor 420 when the vital temperature is low. Adjustments to operating voltage are in the range of 0.05 to 0.1 volts for a typical graphics processor running at 1.8 to 2.0 volts. In this way, the controller 436 reduces the amount of heat generated by the graphics processor 420.

The controller 436 establishes temperature thresholds to control the temperature of the processor 420. The fan logic 438a compares the vital temperature with a first threshold to determine how to adjust the rotational speed of the fan 432, if necessary. Similarly, the power logic 438b compares the vital temperature with second and third temperature thresholds to determine how to adjust the operating clock speed and voltage of the processor 420 respectively. These thresholds are established referencing the required performance and desired noise levels of the cooling system 430. For example, when the processor 420 is mainly involved in performing 2D graphics operations producing little heat, the three thresholds can be set to the same high-level temperature, such as five degrees Celsius below a manufacturer specified critical temperature of the graphics processor 420. In a high performance mode, when the processor 420 is performing substantial amounts of 3D graphics operations and generating considerable heat, multiple thresholds for each cooling function (fan, clock, voltage) can be distributed so that as the temperature rises the fan speed is ramped up, the clock speed is ramped down, and the operating voltage is reduced. The specific quantities and levels of thresholds for each cooling function are determined referencing the expected service of the VGA chipset and sound design principles.

Referring to FIG. 7, a memory 440 is further provided to store threshold levels or other relations between vital temperature and fan speed, clock rate, and operating voltage. Such other relations can be stored in the memory 440 to complement or replace the functions of the thresholds, an example of such being the simple linear relation: fan speed=m * vital temperature+b, where m and b are constants. The memory 440 can be either a RAM or hard disk of a computer system hosting the VGA chipset or a memory internal to the VGA chipset.

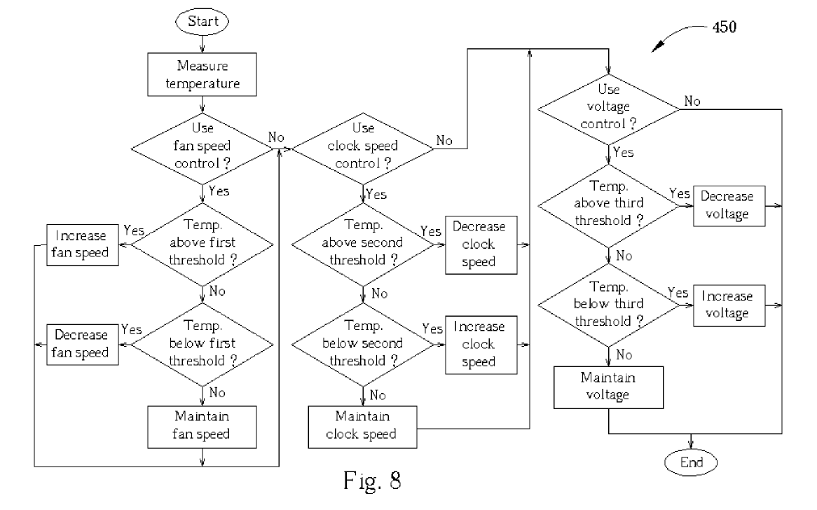

Please refer to FIG. 8 illustrating a flowchart of a method 450 for controlling the temperature of a VGA chipset processor according to the present invention. The method 450 allows for fan speed, clock speed, and operating voltage to be selectively controlled by the controller 436 of FIG. 7 referencing three threshold temperatures. When the measured temperature is above a threshold temperature, the controller 436 effects cooling by increasing fan speed or by decreasing clock rate or operating voltage. When the measured temperature is below a threshold temperature, the controller 436 reduces fan noise by reducing fan speed, increases graphics processor performance by increasing clock rate, or increases processor reliability by increasing operating voltage. Naturally, when there is no significant change in temperature, the controller 436 maintains current settings. In addition, multiple thresholds can be established or a single threshold can be dynamically modified to allow for smooth ramping up and down of each cooling function.

To realize the above-described method, the controller 436 can utilize software or hardware or a suitable combination of the two. That is, fan logic 438a and power logic 438b can be software code, hardware logic gates, or a microprocessor. In addition, according to the present invention, optimized versions of the method 450 can be easily provided. For example, an alternative embodiment of the present invention is a method that does not consider graphics processor voltage.

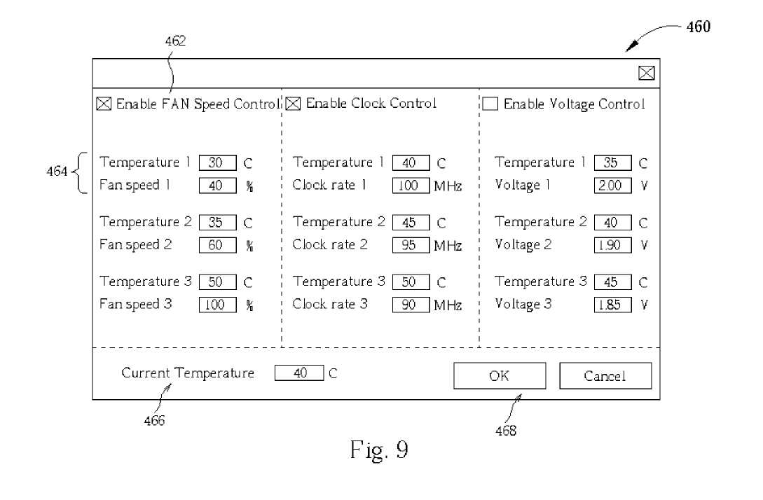

FIG. 9 illustrates a user interface 460 for configuring the present invention VGA cooling system. The user interface 460 is a graphical interface, such as that common in computer applications, and is connected to the controller 436 of the cooling system 430. A user uses a mouse or similar device to make changes to the present invention cooling system through the user interface 460, with changes made and the current state of the cooling system 430 being displayed on a display screen. The user interface 460 includes enable toggles 462 for enabling ordisabling cooling functions of the present invention, a series of temperature thresholds and cooling settings 464 for each cooling function, temperature output 466, and control buttons 468. As can be seen from the example entries of the user interface 460, the cooling system 430 has activated fan speed control and clock speed control with three temperature threshold levels for each. For example, when the graphics processor vital temperature reaches 40 degrees Celsius, the clock rate will be set to 100 Mhz and the fan will be operating at 60% of full speed. At this point, had the voltage control been enabled, the operating voltage of the graphics processor would be reduced to 1.90 volts. In this way, a user can configure and monitor the present invention VGA chipset cooling system 430.

In contrast to the prior art, the present invention provides a cooling system and methods for operation thereof that minimize fan noise while reducing power and maintaining allowable operating temperatures. Specifically, the present invention provides methods that relate changes in computer system vital temperature to changes in fan speed of one or more cooling fans, including a power supply cooling fan. A chipset interface is provided to measure the changes in vital temperature, calculate the corresponding fan speeds, and output a control signal to achieve these fan speeds. The present invention also controls cooling fan speed, and graphics processor clock rate or operating voltage to effectively cool the graphics processor when under load, and reduce fan noise and power consumption when graphics operations are minimal.

Those skilled in the art will readily observe that numerous modifications and alterations of the device may be made while retaining the teachings of the invention. Accordingly, the above disclosure should be construed as limited only by the metes and bounds of the appended claims.

1. A method for controlling an operating temperature of a video graphics array (VGA) chipset, the method comprising:
monitoring a rotational speed of a cooling fan installed on the VGA chipset, the rotational speed of the cooling fan being controlled by a fan power;
monitoring a vital temperature of a graphics processor of the VGA chipset;
increasing the fan power when the vital temperature is substantially above a first threshold to increase the fan speed;
decreasing the fan power when the vital temperature is substantially below the first threshold to decrease the fan speed;
increasing the operating clock speed of the processor when the vital temperature is substantially below a second threshold; and
decreasing the operating clock speed of the processor when the vital temperature is substantially above the second threshold.

2. The method of claim 1 further comprising:
maintaining the fan power when the vital temperature is substantially equal to the first threshold to maintain the fan speed; and
maintaining the operating clock speed when the vital temperature is substantially equal to the second threshold.

3. The method of claim 1 further comprising:
increasing an operating voltage of the processor when the vital temperature is substantially below a third threshold; and
decreasing an operating voltage of the processor when the vital temperature is substantially above the third threshold.

4. The method of claim 1 wherein the vital temperature is obtained from an on-die thermal monitoring transistor of the processor.

5. The method of claim 1 wherein increasing and decreasing the fan power and operating clock speed are controlled by relations stored in a random access memory or hard disk electrically connected to the VGA chipset.

6. The method of claim 1 wherein the first and second thresholds are equal.

7. A method for controlling an operating temperature of a video graphics array (VGA) chipset, the method comprising:
monitoring a rotational speed of a cooling fan installed on the VGA chipset, the rotational speed of the cooling fan being controlled by a fan power;
monitoring a vital temperature a graphics processor of the VGA chipset;
increasing the fan power when the vital temperature is substantially above a first threshold to increase the fan speed;
decreasing the fan power when the vital temperature is substantially below the first threshold to decrease the fan speed;
increasing the operating voltage of the processor when the vital temperature is substantially below a third threshold; and
decreasing the operating voltage of the processor when the vital temperature is substantially above the third threshold.

8. The method of claim 7 further comprising:
maintaining the fan power when the vital temperature is substantially equal to the first threshold to maintain the fan speed; and
maintaining the operating voltage when the vital temperature is substantially equal to the third threshold.

9. The method of claim 7 further comprising:
increasing the operating clock speed of the processor when the vital temperature is substantially below a second threshold; and
decreasing an operating clock speed of the processor when the vital temperature is substantially above the second threshold.

10. The method of claim 7 wherein the vital temperature is obtained from an on-die thermal monitoring transistor of the processor.

11. The method of claim 7 wherein increasing and decreasing the fan power and operating voltage are controlled by relations stored in a random access memory or hard disk electrically connected to the VGA chipset.

12. The method of claim 7 wherein the first and thirdthresholds are equal.

13. A video graphics array (VGA) chipset with cooling system comprising:
a graphics processor having an operating power controlled by an operating power control signal;
a cooling fan for cooling the graphics processor;
a fan input-output module electrically connected to the fan for transmitting a fan control signal to the fan, the fan control signal controlling the rotational speed of the fan;
a controller electrically connected to the fan input-output module and the graphics processor, the controller comprising fan logic for generating the fan control signal based on a vital temperature of the graphics processorand outputting the fan control signal to the fan inputoutput module, and power logic for generating the operating power control signal based on the vital temperature of the graphics processor and outputting the operating power control signal to the graphics processor; and
a temperature transducer connected to the graphics processor for measuring the vital temperature and outputting the vital temperature to the controller.

14. The cooling system of claim 13 wherein the graphics processor comprises a clock speed circuit electrically connected to the controller for receiving the operating power control signal, the graphics processor adjusting an operating clock speed according to input to the clock speed circuit.

15. The cooling system of claim 14 further comprising a memory electrically connected to the controller for storing at least a relation relating the operating clock speed of the graphics processor to the vital temperature.

16. The cooling system of claim 13 wherein the graphics processor comprises a voltage circuit electrically connected to the controller for receiving the operating power control signal, the graphics processor adjusting an operating voltage according to input at the voltage circuit.

17. The cooling system of claim 16 further comprising a memory electrically connected to the controller for storing at least a relation relating the operating voltage of the graphics processor to the vital temperature.

18. The cooling system of claim 13 further comprising a memory electrically connected to the controller for storing at least a relation relating the fan control signal to the vital temperature.

19. The cooling system of claim 13 wherein the temperature transducer is an on-die thermal monitoring transistor of the graphics processor.

20. The cooling system of claim 13 further comprising a user interface electrically connected to the controller, the user interface comprising a display device and an input device for receiving control parameters from an external source; wherein the controller references the control parameters to generate the fan control signal and the operating power control signal.
